(19) United States
(12) Patent Application Publication
(10) Pub. No.: US 2017/0116928 A1
(43) Pub. Date: Apr. 27, 2017

(54) BACKLIGHT UNIT AND DISPLAY APPARATUS INCLUDING THE SAME

(71) Applicant: Samsung Display Co., Ltd., Yongin-si (KR)

(72) Inventor: Donghwan KIM, Seongnam-si (KR)

(21) Appl. No.: 15/165,645

(22) Filed: May 26, 2016

(30) Foreign Application Priority Data
Oct. 23, 2015 (KR) 10-2015-0148281

(51) Int. Cl. G09G 3/34; F21V 23/00; G09G 3/36; G02F 1/1368; G02F 1/1343; G02F 1/1335; G02F 1/1362; H05B 37/02

(52) U.S. Cl. CPC G09G 3/3406; G02F 1/136286; F21V 23/003; H05B 37/0209; G02F 1/1368; G02F 1/136213; G02F 1/134309; G02F 1/133514; G09G 3/3648; G09G 2310/08; G09G 2320/0626

(57) ABSTRACT

A backlight unit includes a backlight including a plurality of light source blocks each including a plurality of light sources, and a backlight driver for driving the light sources, wherein light sources of an Lth light source block, which are adjacent a boundary between the Lth light source block and an (L+1)th light source block, are connected to light sources of the (L+1)th light source block, which are also adjacent the boundary, and wherein L is a natural number.

### CROSS-REFERENCE TO RELATED APPLICATION

This application claims priority to, and the benefit of, Korean Patent Application No. 10-2015-0148281, filed on Oct. 23, 2015, in the Korean Intellectual Property Office, the disclosure of which is incorporated herein in its entirety by reference.

### BACKGROUND

1. Field

The present disclosure herein relates to a backlight unit having excellent display quality, and a display apparatus including the same.

2. Description of the Related Art

In general, a liquid crystal display apparatus may include a display panel in which a plurality of pixels are arranged, a gate driver for providing gate signals to the pixels, a data driver for providing data voltages to the pixels, and a backlight unit for providing light to the display panel.

The pixels may receive the data voltages in response to the gate signals to be driven. The pixels driven by the data voltages may adjust a transmission rate of light provided from the backlight unit to display an image.

The backlight unit may be driven using a dimming method. The dimming method may be a technology for controlling the intensity (or luminance) of light of the backlight unit in consideration of the luminance of an image to reduce power consumption. The dimming method may include an analog dimming method in which the luminance of the backlight unit is adjusted by regulating the amount of current applied to light sources of the backlight unit, and may include a digital dimming method in which the luminance of the backlight unit is adjusted by controlling turning on/off of the light sources.

A local dimming method has been developed to prevent reduction of a contrast ratio (CR), and to minimize or reduce power consumption. According to this method, a backlight may be divided into a plurality of light source blocks, and the luminance of each light source block may be controlled according to the luminance of an image corresponding to each light source block.

### SUMMARY

The present disclosure provides a backlight unit having excellent display quality, and a display apparatus including the same.

An embodiment of the inventive concept provides a backlight unit including a backlight including a plurality of light source blocks each including a plurality of light sources, and a backlight driver for driving the light sources, wherein light sources of an Lth light source block, which are adjacent a boundary between the Lth light source block and an (L+1)th light source block, are connected to light sources of the (L+1)th light source block, which are also adjacent the boundary, and wherein L is a natural number.

The plurality of light sources of each of the Lth light source block and the (L+1)th light source block may include a plurality of first light sources that are adjacent the boundary, and a plurality of second light sources other than the first light sources, the light source blocks may be arranged in a first direction corresponding to a row direction, the first light sources of the Lth light source block and the second light sources of the (L+1)th light source block may be connected in series to each other, and the first light sources of the (L+1)th light source block and the second light sources of the Lth light source block may be connected in series to each other.

The light source block may further include a first terminal for receiving and for providing a driving voltage to the light sources, and a second terminal for receiving and for providing a ground voltage to the light sources.

The first and second light sources may be connected in series to each other define a light source string, a first side of the light source string may be connected to a corresponding first terminal of the first terminals, and a second side of the light source string may be connected to a corresponding second terminal of the second terminals.

The backlight driver may be configured to drive the light source string using an analog dimming method or a digital dimming method to thereby control a luminance of each of the light source blocks.

The plurality of light sources may include a plurality of green light sources configured to generate green light and a plurality of magenta light sources configured to generate magenta light.

The light source blocks may include a plurality of light source units arranged in a matrix form, and each of the light source units may include two of the green light sources or two of the magenta light sources.

The green light sources and the magenta light sources may be alternately arranged in a second direction crossing the first direction.

The green light sources may be arranged in the first direction, and the magenta light sources may be arranged in the first direction.

An embodiment of the inventive concept provides a display apparatus including a display panel, and a backlight unit configured to provide light to the display panel, and including a backlight including a plurality of light source blocks each including a plurality of light sources for generating the light, and a backlight driver configured to drive the light sources, wherein light sources of an Lth light source block, which are adjacent a boundary between the Lth light source block and an (L+1)th light source block, are connected to the (L+1)th light source block, wherein light sources of the (L+1)th light source block, which are adjacent the boundary, are connected to the Lth light source block, and wherein L is a natural number.

The plurality of light sources of each of the Lth light source block and the (L+1)th light source block may include a plurality of first light sources adjacent the boundary, and a plurality of second light sources other than the first light sources, the light source blocks may be arranged in a first direction corresponding to a row direction, among light sources of Hth and (H+1)th rows, the first light sources of the Lth light source block and the second light sources of the (L+1)th light source block may be connected in series to each other, the first light sources of the (L+1)th light source block and the second light sources of the Lth light source block may be connected in series to each other, and H may be an odd natural number.

Each light source block may further include a first terminal for receiving and for providing a driving voltage to the light sources, and a second terminal for receiving and for providing a ground voltage to the light sources.

The first and second light sources connected in series to each other may define a light source string, a first side of the light source string may be connected to a corresponding first terminal of the first terminals, and a second side of the light source string may be connected to a corresponding second terminal of the second terminals.

The backlight driver may be configured to drive the light source string using an analog dimming method or a digital dimming method to thereby control a luminance of each light source block.

The plurality of light sources may include a plurality of green light sources configured to generate green light, and a plurality of magenta light sources configured to generate magenta light, the light source blocks may include a plurality of light source units arranged in a matrix form, each of the light source units may include two of the green light sources or two of the magenta light sources.

The light source units including the green light sources and the light source units including the magenta light sources may be alternately arranged in a second direction crossing the first direction, the green light sources may be arranged in the first direction, and the magenta light sources may be arranged in the first direction.

### BRIEF DESCRIPTION OF THE FIGURES

The accompanying drawings are included to provide a further understanding of the inventive concept, and are incorporated in, and constitute a part of, this specification. The drawings illustrate embodiments of the inventive concept and, together with the description, serve to explain principles of the inventive concept. In the drawings:

FIG. 1 is a block diagram illustrating a display apparatus according to an embodiment of the inventive concept;

FIG. 2 is an equivalent circuit diagram of one of the pixels illustrated in FIG. 1;

FIG. 3 is a diagram illustrating the dimming blocks of the display panel of FIG. 1, and the light source blocks of the backlight corresponding to the dimming blocks;

FIG. 4 is a diagram illustrating a configuration of the light source blocks of the backlight illustrated in FIG. 3;

FIG. 5A is a diagram illustrating the luminances of dimming blocks of a comparative display apparatus; and

FIG. 5B is a diagram illustrating the luminances of dimming blocks of a display apparatus according to an embodiment of the inventive concept.

### DETAILED DESCRIPTION

Features of the inventive concept and methods of accomplishing the same may be understood more readily by reference to the following detailed description of embodiments and the accompanying drawings. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

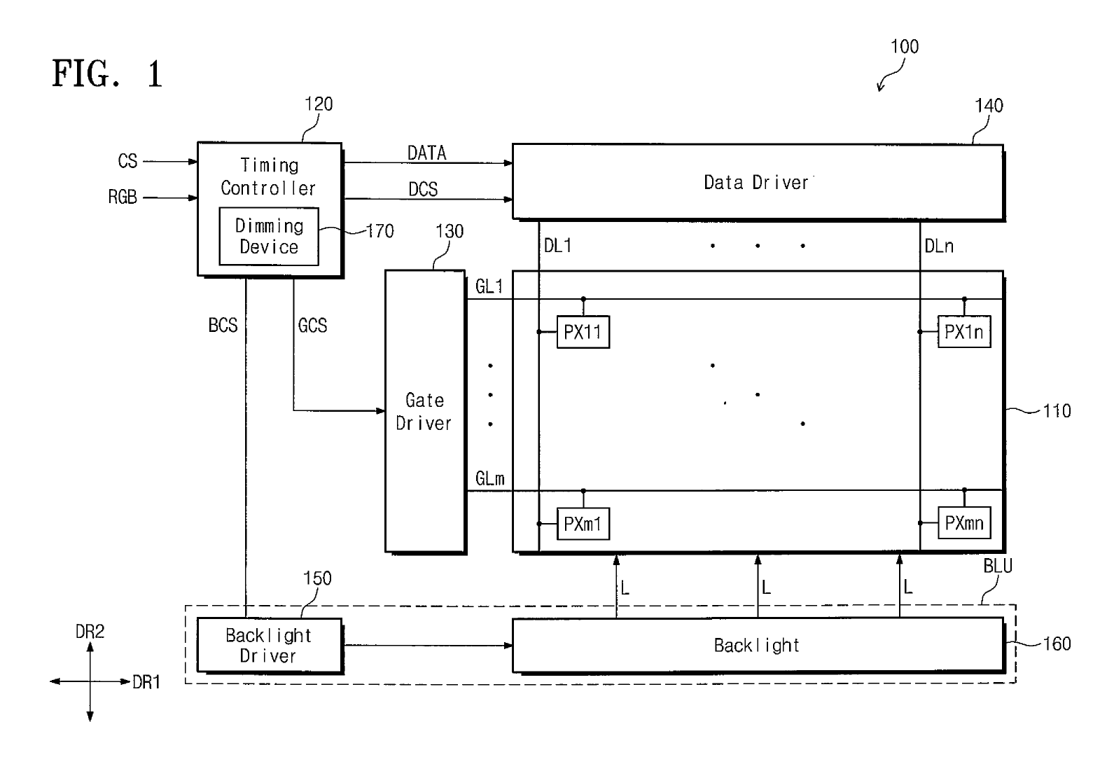

FIG. 1 is a block diagram illustrating a display apparatus according to an embodiment of the inventive concept.

Referring to FIG. 1, a display apparatus 100 according to an embodiment of the inventive concept may include a display panel 110, a timing controller 120, a gate driver 130, a data driver 140, and a backlight unit (BLU). The BLU includes a backlight driver 150 and a backlight 160.

The display panel 110 may be a liquid crystal display panel including two substrates facing each other, and a liquid crystal layer therebetween. The display panel 110 may include a plurality of gate lines GL1 to GLm, a plurality of data lines DL1 to DLn, and a plurality of pixels PX11 to PXmn, where m and n are natural numbers.

The gate lines GL1 to GLm may extend in a first direction DR1, and may be connected to the gate driver 130. The data lines DL1 to DLn may extend in a second direction DR2 crossing the first direction DR1, and may be connected to the data driver 140. The first direction DR1 may correspond to a row direction, and the second direction DR2 may correspond to a column direction.

The pixels PX11 to PXmn may be arranged on regions divided by the gate lines GL1 to GLm and the data lines DL1 to DLn crossing each other. Accordingly, the pixels PX11 to PXmn may be ranged in a matrix form. The pixels PX11 to PXmn may be connected to the gate lines GL1 to GLm and the data lines DL1 to DLn.

The pixels PX11 to PXmn may display red, green, or blue color. However, an embodiment of the inventive concept is not limited thereto, and the pixels PX11 to PXmn may further display various colors such as white, yellow, cyan, magenta, etc.

The timing controller 120 may be mounted on a printed circuit board in the form of an integrated circuit chip to be connected to the gate driver 130 and the data driver 140. The timing controller 120 may receive externally supplied image signals RGB and an externally supplied control signal CS (e.g., supplied from a system board).

The timing controller 120 may convert a data format of the image signals RGB so that the image signals are compatible with an interface with the data driver 140. The timing controller 120 may provide data-format-converted image data DATA to the data driver 140.

The timing controller 120 may generate a gate control signal GCS and a data control signal DCS. The gate control signal GCS may be a control signal for controlling an operation timing of the gate driver 130. The data control signal DCS may be a control signal for controlling an operation timing of the data driver 140.

The timing controller 120 may analyze the image signals RGB to generate a backlight control signal BCS for controlling a luminance of the BLU. The backlight control signal BCS may be a control signal for driving the BLU using a local dimming method.

The timing controller 120 may include a dimming device 170 for generating the backlight control signal BCS. The dimming device 170 generates the backlight control signal BCS using the image data DATA provided to the data driver 140.

As a non-limiting example, the display panel 110 may be divided into a plurality of dimming blocks, and the backlight 160 may be divided into light source blocks corresponding to respective ones of the dimming blocks. The dimming device 170 may analyze the image data DATA corresponding to the dimming blocks to generate the backlight control signal BCS for individually controlling the luminances of the light source blocks.

The backlight control signal BCS may include a plurality of pulse width modulation (PWM) signals corresponding to the light source blocks. The PWM signals may be used to control the luminances of corresponding light source blocks of the plurality of light source blocks. A duty ratio of the PWM signal for driving each light source block may be adjusted according to the luminance of an image displayed on each dimming block.

The timing controller 120 may provide the gate control signal GCS to the gate driver 130, and may provide the data control signal DCS to the data driver 140. The timing controller 120 may provide the backlight control signal BCS to the backlight unit BLU.

The gate driver 130 may generate gate signals in response to the gate control signal GCS. The gate signals may be sequentially output. The gate signals may be provided to the pixels PX11 to PXmn through the gate lines GL1 to GLm.

The data driver 140 may generate and output analog data voltages corresponding to the image data DATA in response to the data control signal DCS. The data voltages may be provided to the pixels PX11 to PXmn through the data fines DL1 to DLn.

The gate driver 130 and the data driver 140 may provide a plurality of driving chips to be mounted on a flexible printed circuit board, and may be connected to the display panel 110 using a tape carrier package (TCP) technology. However, the inventive concept is not limited thereto, and the gate driver 130 and the data driver 140 may provide a plurality of driving chips to be mounted on the display panel 110 using a chip on glass (COG) technology. Furthermore, the gate driver 130 may be formed simultaneously with (e.g., may be formed during a same process as) transistors of the pixels PX11 to PXmn, and may be mounted on the display panel 110 as an amorphous silicon TFT gate (ASG) driver circuit or an oxide silicon TFT gate (OSG) driver circuit.

The backlight driver 150 may drive the backlight 160 in response to the backlight control signal BCS using a local dimming method. As a non-limiting example, the backlight driver 150 may receive the PWM signals of the backlight control signal BCS, and may individually control the luminances of the light source blocks according to the PWM signals. The backlight driver 150 may drive the backlight 160 using an analog dimming method or using a digital dimming method according to the PWM signals.

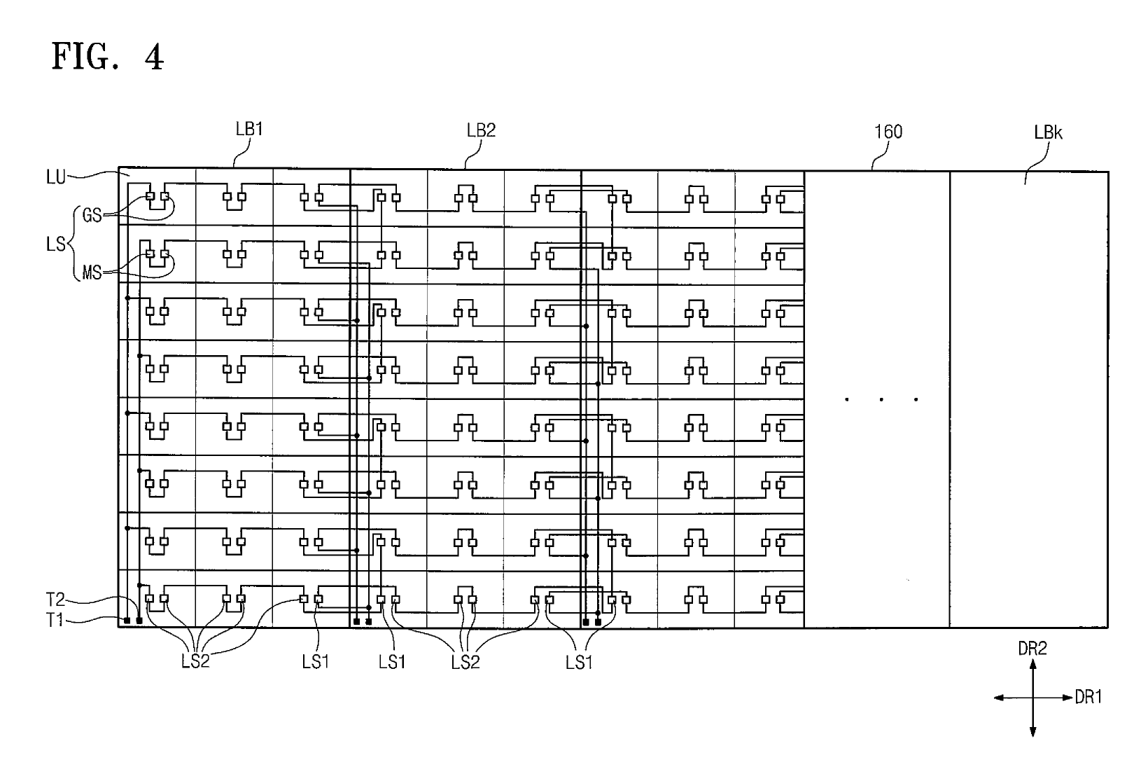

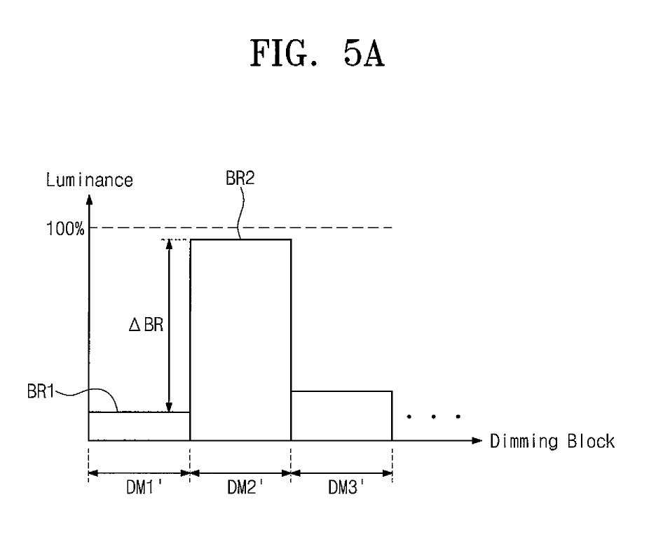

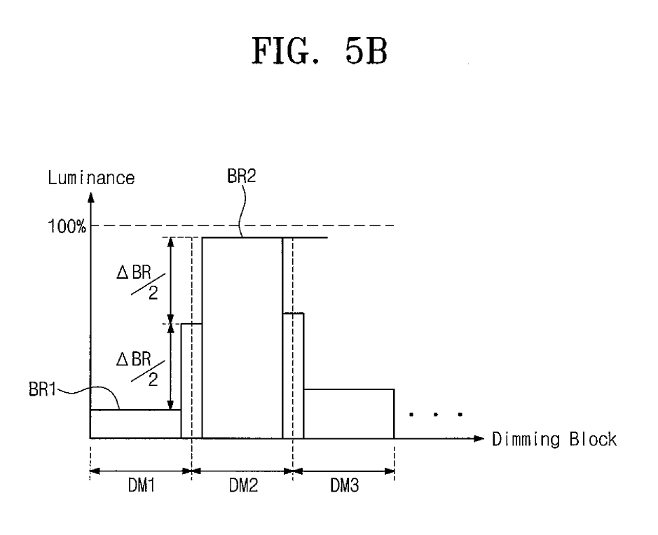

Regions of adjacent light source blocks (e.g., predetermined regions), which may be adjacent a boundary between the adjacent light source blocks, may generate light having an intermediate luminance between the luminances of the adjacent light source blocks. This configuration will be described in more detail with reference to FIGS. 4, 5A, and 5B.

The backlight 160 may include light-emitting diodes or a cold cathode fluorescent lamp as a light source for generating light L. The backlight 160 may be located at the rear of the display panel 110, and the light L generated by the backlight 160 may be provided to the display panel 110.

The display panel 110 may display an image using the light L provided from the backlight 160. The pixels PX11 to PXmn may receive the data voltages through the data lines DL1 to DLn in response to the gate signals received through the gate lines GL1 to GLm.

The pixels PX11 to PXmn may display gradations corresponding to the data voltages so that an image may be displayed. The pixels PX11 to PXmn driven by the data voltages may adjust a transmission rate of the light provided from the backlight 160 to display an image.

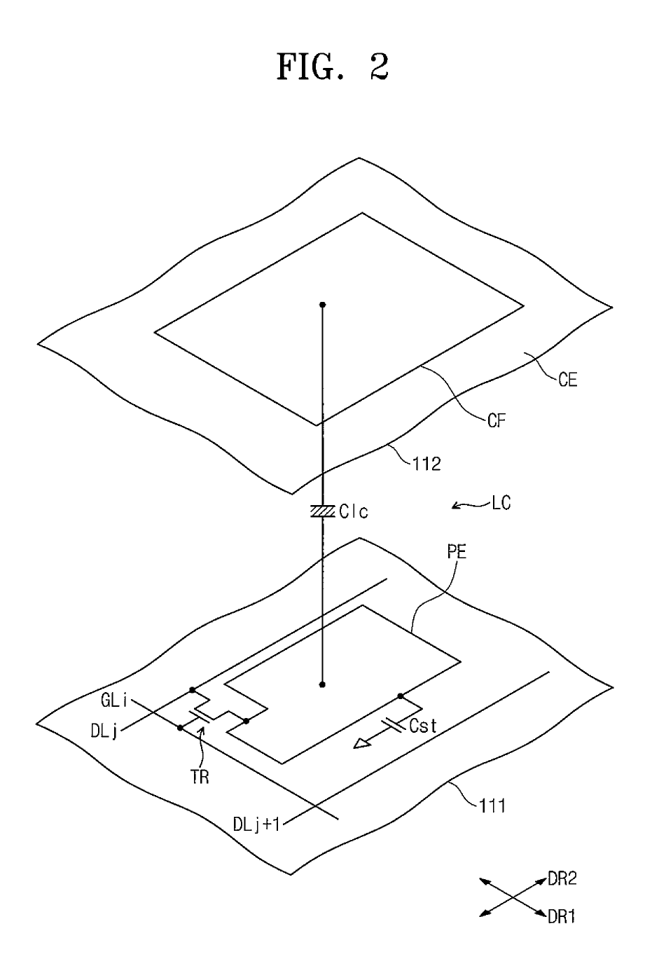

FIG. 2 is an equivalent circuit diagram of one of the pixels illustrated in FIG. 1.

For convenience, FIG. 2 illustrates a pixel PX connected to a gate line GLi and a data line DLj. Other pixels of the display panel 110 may have the same structure as the pixel PX illustrated in FIG. 2.

Referring to FIG. 2, the display panel 110 may include a first substrate 111, a second substrate 112 facing the first substrate 111, and a liquid crystal layer LC between the first substrate 111 and the second substrate 112.

The pixel PX may include a transistor TR connected to the gate line GLi and to the data line DLj, a liquid crystal capacitor Clc connected to the transistor TR, and a storage capacitor Cst connected in parallel to the liquid crystal capacitor Clc. In other embodiments, the storage capacitor Cst may be omitted.

The transistor TR may be on the first substrate 111. The transistor TR may include a gate electrode connected to the gate line GLi, a source electrode connected to the data line DLj, and a drain electrode connected to the liquid crystal capacitor Clc and to the storage capacitor Cst.

The liquid crystal capacitor Clc may include a pixel electrode PE on the first substrate 111, a common electrode CE on the second substrate 112, and the liquid crystal layer LC between the pixel electrode PE and the common electrode CE. The liquid crystal layer LC may serve as a dielectric. The pixel electrode PE may be connected to the drain electrode of the transistor TR.

The pixel electrode PE of FIG. 2 may have a non-slit structure, but is not limited thereto, and may have a slit structure including a cross-shaped stem part and a plurality of branch parts extending radially from the stem part.

The common electrode CE may be formed over the second substrate 112. However, the inventive concept is not limited thereto, and the common electrode CE may be on the first electrode 111. In this case, at least one of the pixel electrode PE or the common electrode CE may include a slit.

The storage capacitor Cst may include the pixel electrode PE, a storage electrode branched from a storage line, and an insulating layer between the pixel electrode PE and the storage electrode. The storage line may be on the first substrate 111, may be formed simultaneously with, or during a same process as, the gate lines GL1 to GLm, and may be at the same layer as that of the gate lines GL1 to GLm. The storage electrode may partially overlap with the pixel electrode PE.

The pixel PX may further include a color filter CF presenting one of red, green, and blue colors. In an embodiment of the inventive concept, the color filter CF may be on the second substrate 112, as illustrated in FIG. 2. However, the inventive concept is not limited thereto, and the color filter CF may be on the first electrode 111.

The transistor TR may be turned on in response to a gate signal received through the gate line GLi. A data voltage received through the data line DLj may be provided to the pixel electrode PE of the liquid crystal capacitor Clc through the turned-on transistor TR. A common voltage may be applied to the common electrode CE.

An electric field may be induced between the pixel electrode PE and the common electrode CE according to a voltage level difference between the data voltage and the common voltage. Liquid crystal molecules of the liquid crystal layer LC may be driven by the electric field induced between the pixel electrode PE and the common electrode CE. The transmission rate of the light provided from the backlight 160 may be adjusted by the liquid crystal molecules driven by the electric field, so that an image may be displayed.

A storage voltage having a certain level may be applied to the storage line. However, the inventive concept is not limited thereto, and the storage line may receive the common voltage. The storage capacitor Cst may serve to complement a voltage charged in the liquid crystal capacitor Clc.

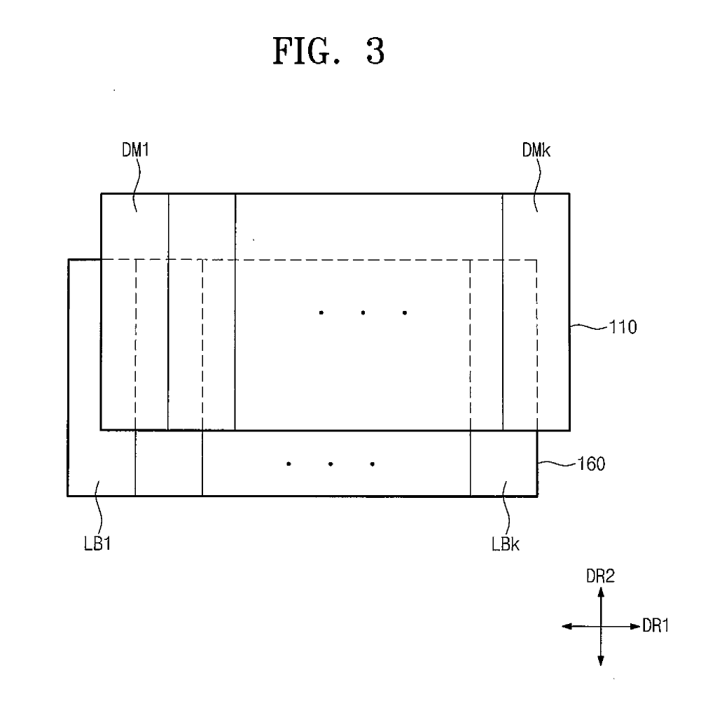

FIG. 3 is a diagram illustrating the dimming blocks of the display panel of FIG. 1, and the light source blocks of the backlight corresponding to the dimming blocks.

Referring to FIG. 3, the display panel 110 may include a plurality of dimming blocks DM1 to DMk arranged in the first direction DR1. The backlight 160 may include a plurality of light source blocks LB1 to LBk arranged in the first direction DR1. As a non-limiting example, k may be a natural number larger than 1. The light source blocks LB1 to LBk may be arranged under the dimming blocks DM1 to DMk to respectively correspond to the dimming blocks DM1 to DMk.

The dimming device 170 may generate and output k PWM signals corresponding to the light source blocks LB1 to LBk. The backlight driver 150 may control the luminances of lights respectively generated by the light source blocks LB1 to LBk, according to respective duty ratios of the k PWM signals.

The lights generated by respective light source blocks LB1 to LBk may be provided to corresponding dimming blocks of the dimming blocks DM1 to DMk. As a result, the dimming blocks DM1 to DMk of the display panel 110 may receive lights having different intensities.

FIG. 4 is a diagram illustrating a configuration of the light source blocks of the backlight illustrated in FIG. 3.

Referring to FIG. 4, each of the light source blocks LB1 to LBk includes a plurality of light source units LU arranged in the first direction DR1 and the second direction DR2 to form a matrix. Although FIG. 4 illustrates that each of the light source blocks LB1 to LBk includes the light source units LU arranged in eight rows and three columns, the number of the light source units LU is not limited thereto.

The light source units LU may include a plurality of light sources LS for generating light. The light sources LS may include a plurality of green light sources GS for generating green light, and a plurality of magenta light sources MS for generating magenta light.

The light source units LU may include green light sources GS and magenta light sources MS. The light source units LU may be arranged in the first direction DR1, and may be alternately arranged in the second direction DR2. However, the inventive concept is not limited thereto, and the light source units LU may include green light sources GS and magenta light sources MS. The light source units LU may be arranged in the second direction DR2, and may be alternately arranged in the first direction DR1.

White light may be generated by mixing green light generated by the green light sources GS with magenta light generated by the magenta light sources MS. As a result, white light may be generated by the light source blocks LB1 to LBk and may be provided to the display panel 110.

Although FIG. 4 illustrates the green light sources GS and the magenta light sources MS, the inventive concept is not limited thereto, and the light source units LU may include light sources LS for generating lights having various colors. As a non-limiting example, the light source units LU may include light sources LS for generating red, green, and blue lights. The red, green, and blue lights generated by the light sources LS may be mixed to generate white light.

Each light source unit LU may include two green light sources GS or two magenta light sources MS. However, the number of the light sources LS of each light source unit LU is not limited thereto. As a non-limiting example, each light source unit LU may include red, green, and blue light sources, or may include three light sources for generating one of red, green, and blue lights.

The light source units LU may include green light sources GS, which may be arranged in the first direction DR1. The light source units LU may also include the magenta light sources MS, which may be arranged in the first direction DR1. However, the inventive concept is not limited thereto, and the green light sources GS and the magenta light sources MS of the light source units LU may be arranged in the second direction DR2.

The light sources LS of each light source block that are adjacent a boundary between adjacent ones of the light source blocks may be connected to an adjacent light source block. In detail, the light sources LS of an Lth light source block, which are adjacent a boundary between the Lth light source block and an adjacent (L+1)th light source block among the light source blocks LB1 to LBk, are connected to the (L+1)th light source block. The light sources LS of the (L+1)th light source block, which are adjacent the boundary between the adjacent Lth light source block and the (L+1)th light source block among the light source blocks LB1 to LBk, may be connected to the Lth light source block. L may be a natural number.

Each of the Lth light source block and the (L+1)th light source block may include a plurality of first light sources LS1, which are light sources LS adjacent the boundary between the Lth light source block and the (L+1)th light source block, and a plurality of second light sources LS2, which are light sources LS that are other than the first light sources LS1. The second light sources LS2 may represent light sources LS that are not adjacent boundaries among the light source blocks LB1 to LBk.

Among the light sources LS of an Hth row and an (H+1)th row, the first light sources LS1 of the Lth light source block and the second light sources LS2 of the (L+1)th light source block may be respectively connected in series to each other. Among the light sources LS of the Hth row and the (H+1)th row, the first light sources LS1 of the (L+1)th light source block and the second light sources LS2 of the Lth light source block may be connected in series to each other. H may be an odd natural number. Further, as shown in FIG. 4, one of the first light sources LS1 of the Hth row of the second light source block LB2, and one of the first light sources LS1 of the (H+1)th row of the second light source block LB2, may be connected in series.

As a non-limiting example, if H is 1, then among the light sources LS of first and second rows, the first light sources LS1 of a second light source block LB2, which are adjacent the boundary between the adjacent first and second light source blocks LB1 and LB2, and the second light sources LS2 of the first light source block LB1, may be connected in series to each other.

Furthermore, among the light sources LS of the first and second rows, the first light sources LS1 of the first light source block LB1, which may be adjacent the boundary between the adjacent first and second light source blocks LB1 and LB2, the first light sources LS1 of a third light source block LB3, which are adjacent the boundary between the adjacent second and third light source blocks LB2 and LB3, and the second light sources LS2 of the second light source block LB2, may be connected in series to each other.

Although a connection structure of the first to third light source blocks LB1 to LB3 have been described, the other light source blocks have the same connection structure as that of the first to third light source blocks LB1 to LB3. Hereinafter, in the Hth and (H+1)th rows, the light sources LS connected in series to each other may be defined as a light source string.

Each of the light source blocks LB1 to LBk may include a first terminal T1 for receiving a driving voltage from the backlight driver 150, and may include a second terminal T2 for receiving a ground voltage from the backlight driver 150. One side of each light source string arranged in the Hth and (H+1)th rows may be connected to a corresponding first terminal T1 among the first terminals T1 of the light source blocks LB1 to LBk, and the other side of each light source string may be connected to a corresponding second terminal T2 among the second terminals T2 of the light source blocks LB1 to LBk.

The light source strings may be driven by the driving voltage to generate light. As described above, the backlight driver 150 may drive the light source strings using an analog dimming method, or using a digital dimming method, to thereby control the luminance of each of the light source blocks LB1 to LBk.

FIG. 5A is a diagram illustrating the luminances of dimming blocks of a comparative display apparatus, and FIG. 5B is a diagram illustrating the luminances of dimming blocks of a display apparatus according to an embodiment of the inventive concept.

Light sources of each light source block of the comparative display apparatus may be connected in series to each other in each light source block, unlike an embodiment of the inventive concept. That is, the light sources of each light source block of the comparative display apparatus are not connected to any of the light sources of an adjacent light source block.

Referring to FIG. 5A, a first dimming block DM1′ of the comparative display apparatus may have a first luminance BR1 by virtue of light received from a first light source block. The second dimming block DM2′ may have a second luminance BR2 by virtue of light received from a second light source block.

In the case where a luminance difference between the first dimming block DM1′ and the second dimming block DM2′ has a value (e.g., predetermined luminance value or higher), a boundary between the first dimming block DM1′ and the second dimming block DM2′ may be visually recognized as a line. That is, when the luminance difference between the first dimming block DM1′ and the second dimming block DM2′ is rapidly changed by the luminance value or higher (e.g., changed by the predetermined luminance value or higher), the boundary between the first dimming block DM1′ and the second dimming block DM2′ may be visually recognized as a line.

A luminance difference ΔBR between the first luminance BR1 and the second luminance BR2 may be larger than the above described luminance value. Therefore, the boundary between the first dimming block DM1′ and the second dimming block DMZ may be visually recognized as a line.

Referring to FIG. 5B, a driving voltage corresponding to the first luminance BR1 may be applied to the first light source block LB1 so that the first light source block LB1 generates light having the first luminance BR1. A driving voltage corresponding to the second luminance BR2 may be applied to the second light source block LB2 so that the second light source block LB2 generates light having the second luminance BR2.

According to the above-mentioned connection structure of the light sources LS of the first and second light source blocks LB1 and LB2, the first light sources LS1 of the first light source block LB1 may receive the driving voltage applied to the second light source block LB2. Furthermore, the first light sources LS1 of the second light source block LB2, which are adjacent the boundary between the first and second light source blocks LB1 and LB2, may receive the driving voltage applied to the first light source block LB1.

The first light sources LS1 of the first light source block LB1 receive the driving voltage corresponding to the second luminance BR2. The first light sources LS1 of the second light source block LB2, which may be adjacent the boundary between the first and second light source blocks LB1 and LB2, receive the driving voltage applied to the first luminance BR1.

In this case, a region in which the first light sources LS1 of the first and second light source blocks LB1 and LB2, the first light sources LS1 being adjacent the boundary between the first and second light source blocks LB1 and LB2, may generate light having an intermediate luminance that is between the first luminance BR1 and the second luminance BR2. A luminance difference ΔBR/2 between the first luminance BR1 and the intermediate luminance may be equal to a luminance difference ΔBR/2 between the second luminance BR2 and the intermediate luminance.

Therefore, regions (e.g., predetermined regions of the first and second dimming blocks DM1 and DM2) of the display panel 110, the regions being adjacent to a boundary between the first and second dimming blocks DM1 and DM2, may display the intermediate luminance, which is a luminance that is between the first and second luminances BR1 and BR2.

The regions of the first and second dimming blocks DM1 and DM2 of the display panel 110, which are adjacent the boundary between the first and second dimming blocks DM1 and DM2, may correspond to regions of the first and second light source blocks LB1 and LB2 in which the first light sources LS1 are arranged.

The intermediate luminance between the first and second luminances BR1 and BR2 may be smaller than the above described luminance value, which is a luminance value at which the boundary between the first and second dimming blocks DM1 and DM2 are visually recognizable. The luminances of the first and second dimming blocks DM1 and DM2 illustrated in FIG. 5B may be changed more gradually than the luminances of the first and second dimming blocks DM1′ and DM2′ illustrated in FIG. 5A. Therefore, the boundary between the first dimming block DM1 and the second dimming block DM2 might not be visually recognized.

Although the first and second dimming blocks DM1 and DM2 corresponding to the first and second light source blocks LB1 and LB2 have been described, a boundary between adjacent dimming blocks might not be visually recognized from the other dimming blocks.

In an embodiment of the inventive concept, the light sources LS adjacent to a boundary between adjacent light source blocks may generate light having an intermediate luminance between the luminances of the adjacent light source blocks. Therefore, regions (e.g., predetermined regions of the adjacent dimming blocks), which are adjacent to the boundary between the adjacent light source blocks, display the intermediate luminance between the luminances of the adjacent dimming blocks. As such, the luminances of the adjacent dimming blocks may thereby reduce or prevent a phenomenon in which a boundary between dimming blocks is visually recognized.

As a result, the BLU and the display apparatus 100 according to an embodiment of the inventive concept may reduce or prevent the phenomenon in which the boundaries among the dimming blocks DM1 to DMk are visually recognized, so that the display quality may be improved.

Although the embodiments of the present invention have been described, it is understood that the present invention should not be limited to these embodiments but various changes and modifications can be made by one ordinary skilled in the art within the spirit and scope of the present invention as defined by the following claims and their equivalents.

What is claimed is:

1. A backlight unit comprising:
a backlight comprising a plurality of light source blocks each comprising a plurality of light sources; and
a backlight driver for driving the light sources,
wherein light sources of an Lth light source block, which are adjacent a boundary between the Lth light source block and an (L+1)th light source block, are connected to light sources of the (L+1)th light source block, which are also adjacent the boundary, and
wherein L is a natural number.

2. The backlight unit of claim 1, wherein the plurality of light sources of each of the Lth light source block and the (L+1)th light source block comprises:
a plurality of first light sources that are adjacent the boundary; and
a plurality of second light sources other than the first light sources,
wherein the light source blocks are arranged in a first direction corresponding to a row direction,
wherein the first light sources of the Lth light source block and the second light sources of the (L+1)th light source block are connected in series to each other, and the first light sources of the (L+1)th light source block and the second light sources of the Lth light source block are connected in series to each other.

3. The backlight unit of claim 2, wherein each light source block further comprises:
a first terminal for receiving and for providing a driving voltage to the light sources; and
a second terminal for receiving and for providing a ground voltage to the fight sources.

4. The backlight unit of claim 3, wherein the first and second light sources connected in series to each other define a light source string,
wherein a first side of the light source string is connected to a corresponding first terminal of the first terminals, and
wherein a second side of the light source string is connected to a corresponding second terminal of the second terminals.

5. The backlight unit of claim 4, wherein the backlight driver is configured to drive the light source string using an analog dimming method or a digital dimming method to thereby control a luminance of each of the light source blocks.

6. The backlight unit of claim 2, wherein the plurality of light sources comprises:
a plurality of green light sources configured to generate green light; and
a plurality of magenta light sources configured to generate magenta light.

7. The backlight unit of claim 6, wherein the light source blocks comprise a plurality of light source units arranged in a matrix form, and
wherein each of the light source units comprises two of the green light sources or two of the magenta light sources.

8. The backlight unit of claim 7, wherein the green light sources and the magenta light sources are alternately arranged in a second direction crossing the first direction.

9. The backlight unit of claim 7, wherein the green light sources are arranged in the first direction, and
wherein the magenta light sources are arranged in the first direction.

10. A display apparatus comprising:
a display panel; and
a backlight unit configured to provide light to the display panel, and comprising:
a backlight comprising a plurality of light source blocks each comprising a plurality of light sources for generating the light; and
a backlight driver configured to drive the light sources,
wherein light sources of an Lth light source block, which are adjacent a boundary between the Lth light source block and an (L+1)th light source block, are connected to the (L+1)th light source block,
wherein light sources of the (L+1)th light source block, which are adjacent the boundary, are connected to the Lth light source block, and
wherein L is a natural number.

11. The display apparatus of claim 10, wherein the plurality of light sources of each of the Lth light source block and the (L+1)th light source block comprises:
a plurality of first light sources adjacent the boundary; and
a plurality of second light sources other than the first light sources,
wherein the light source blocks are arranged in a first direction corresponding to a row direction,
wherein, among light sources of Hth and (H+1)th rows, the first light sources of the Lth light source block and the second light sources of the (L+1)th light source block are connected in series to each other,
wherein the first light sources of the (L+1)th light source block and the second light sources of the Lth light source block are connected in series to each other, and
wherein H is an odd natural number.

12. The display apparatus of claim 11, wherein each light source block further comprises:
a first terminal for receiving and for providing a driving voltage to the light sources; and
a second terminal for receiving and for providing a ground voltage to the light sources.

13. The display apparatus of claim 12, wherein the first and second light sources connected in series to each other define a light source string,
wherein a first side of the light source string is connected to a corresponding first terminal of the first terminals, and
wherein a second side of the light source string is connected to a corresponding second terminal of the second terminals.

14. The display apparatus of claim 13, wherein the backlight driver is configured to drive the light source string using an analog dimming method or a digital dimming method to thereby control a luminance of each light source block.

15. The display apparatus of claim 11, wherein the plurality of light sources comprises:
a plurality of green light sources configured to generate green light; and
a plurality of magenta light sources configured to generate magenta light,
wherein the light source blocks comprise a plurality of light source units arranged in a matrix form, each of the light source units comprising two of the green light sources or two of the magenta light sources.

16. The display apparatus of claim 15, wherein the light source units comprising the green light sources and the light source units comprising the magenta light sources are alternately arranged in a second direction crossing the first direction,
wherein the green light sources are arranged in the first direction, and
wherein the magenta light sources are arranged in the first direction.
